(19) United States
(12) Patent Application Publication
(10) Pub. No.: US 2006/0168545 A1
(43) Pub. Date: Jul. 27, 2006

(54) System and method for utilizing idle mode on an electronic device

(75) Inventors: Anu Niittynen, Tampere (FI); Ari Tolonen, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/042,220

(22) Filed: Jan. 25, 2005

(51) Int. Cl. G06F 3/00; G06F 17/00; G06F 9/00

(52) U.S. Cl. 715/848; 715/810; 715/864

(57) ABSTRACT

A system and method for providing a three-dimensional object on a display of an electronic device when the electronic device is in an idle mode. The three-dimensional object enables a user to both view and manipulate more material than would otherwise be available while the device is in an idle mode. The three-dimensional object can be customized by the user so that material of particular interest to the user appears when the device is in the idle mode.

### FIELD OF THE INVENTION

The present invention relates generally to electronic devices including an idle mode. More particularly, the present invention relates to material that appears on an electronic device during such idle modes.

### BACKGROUND OF THE INVENTION

In addition to other functions, in many instances certain graphics will appear on a device display when the device is in an idle mode. As a base level, the display may, by default, include a manufacturer or supplier's logo when the device is in an idle mode. Additionally, individual software or hardware manufacturers or distributors may include more advanced graphics, changing images, or other features on the display when the device is idle.

In addition to the above, it may also be desirable to exhibit useful information to the user when the device is in an idle mode. For example, some conventional systems permit a user to observe items such as upcoming appointments when the device is in an idle mode. In some systems, the user is actually capable of manipulating information shown in the idle mode. In these “active idle” systems, a user may be able to mark off appointment reminders or perform similar actions.

Although conventional systems are moderately useful, they suffer from a number of drawbacks. Due to the limited amount of space available on a device display, many conventional systems are quite limited in what they are capable of exhibiting on the display when in a safe mode, and what can be manipulated by the user in “active idle” systems. For example, although European Patent No. 1,206,730 B1, granted on Jan. 14, 2004, describes a system where calendar unique messages can be automatically displayed corresponding to particular calendar dates when the system is in a “standby” mode, it does not provide the ability to display a wide variety of information at a single time, nor does it provide the user with the ability to manipulate the displayed information once it has appeared, instead only providing the user with the ability to customize information before it is displayed. In systems where such information is not shown, there is even less of a benefit to a user, as no useful information is being displayed when the device is in idle mode.

### SUMMARY OF THE INVENTION

The present invention involves a system and method for having a three-dimensional object appear on a display when an associated electronic device is in an idle mode. By exhibiting a three-dimensional object in idle mode, a user is capable of viewing more content during the idle mode than is possible using conventional systems, making the display much more useful to the user when the device is in the idle mode by enabling a user to both view and manipulate additional material, providing enhanced data handling for the user and providing improved data management.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1;

FIG. 3 is an image of a display for a device in idle mode, including a three-dimensional object according to one embodiment of the present invention; and

FIG. 4 is a flow chart showing the process for the implementation of a three-dimensional idle object according to one embodiment of the present invention.

### DETAILED DESCRIPTION OF THE INVENTION

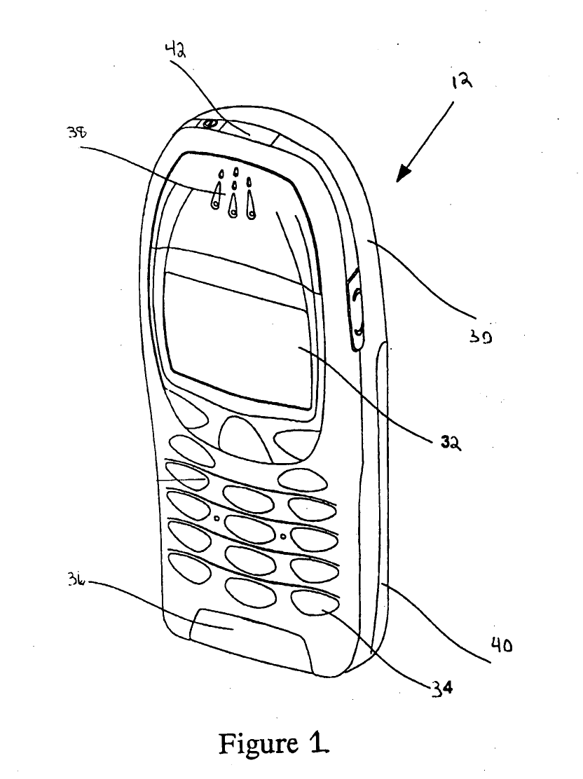

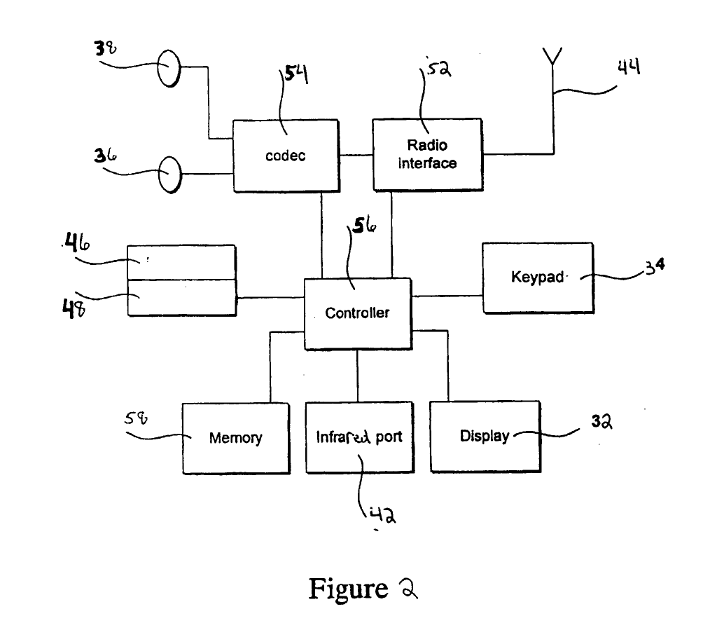

FIGS. 1 and 2 show one representative mobile telephone 12 upon which the present invention may be implemented. However, it is important to note that the present invention is not limited to any type of electronic device and could be incorporated into devices such as personal digital assistants, personal computers, and other devices. It should be understood that the present invention could be incorporated on a wide variety of mobile telephones 12. The mobile telephone 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a card reader 48, radio interface circuitry 52, codec circuitry 54, a controller 56 and a memory 58. It should be noted that the controller 56 can be the same unit or a different unit than the camera processor 16. Individual circuits and elements are all of a type well known in the art, for example in the Nokia range of mobile telephones.

Many currently-manufactured mobile phones, like other electronic devices, have an “idle mode.” An idle mode of a mobile telephone is a basic mode where a user in current implementations can, for example, initiate a phone call or other functions. An idle mode may also present information such as upcoming calendar events, missed or received calls and/or some other information that might be of interest to the user. As used herein, the term “idle mode” refers to a mode where the system, though for some users seemingly even in an inactive state, will react to activity generated by the electronic device. This is in contrast to programs such as “screen savers,” where events generated by the electronic device do not cause the screen saver to disappear or to stop operating.

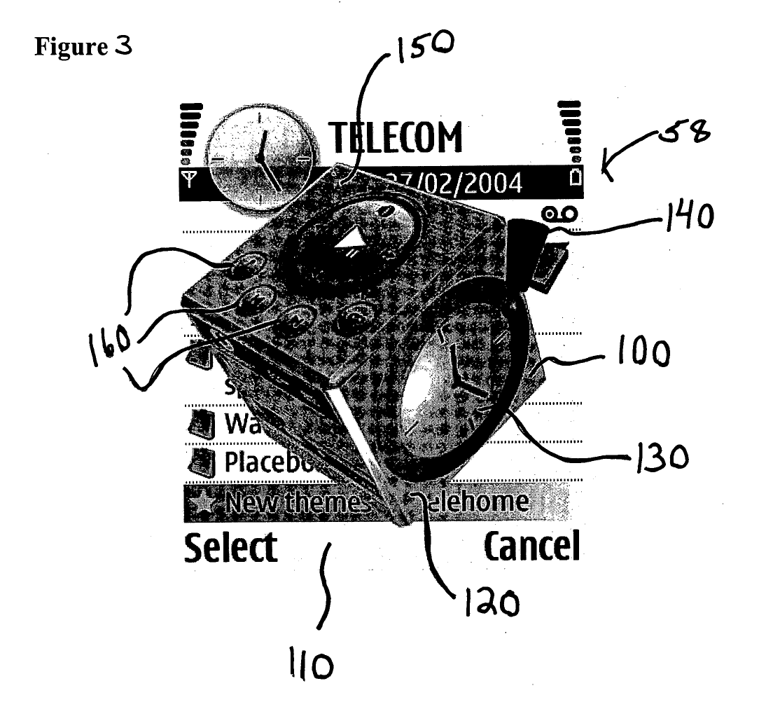

FIG. 3 shows a representative display showing one implementation of the present invention. In the display 32 of FIG. 3, a three-dimensional object 100 is shown superimposed over the screen layout 110. The three-dimensional object 100 shown in FIG. 3 is cube-shaped. However, the three-dimensional object 100 can take a virtually unlimited variety of shapes, including, but not limited, to spherical, spheroidal, trapezoidal, triangular, rectangular-shapes, as well as shapes of everyday objects such as books, houses, appliances, etc.

The three-dimensional object 100 of FIG. 3 includes a plurality of sides that are viewable and/or manipulable by the user. For example, a first side 120 of the three-dimensional object 100 includes a clock 130 showing the current time. The first side 120, in this particular embodiment, also includes an indicator 140 that can be used in the event that the current time coincides with a planned appointment. The second side 150 of the three-dimensional object 100 includes a plurality of input buttons 160 to permit a user to use a media content player. The media content player could also present information such as the name of a song that is playing, or other information.

A wide variety of features, functions, and applications can be placed on the various sides or surfaces of the three-dimensional object 100. By example only, these items may include text documents, clocks, calendars, spreadsheets, graphic images, video clips, animations, application-in-progress screens for firewall, anti-virus, anti-spy-ware and anti-spam applications, distributed computing project screens, electronic mailboxes, instant message-related screens, weather information, financial information, a user's “to do” list, contact information, service advertisements, product advertisements, sponsor advertisements, user interface components, views and other items. These various features or applications can be set by the user, or they could be selected by a hardware, software or content provider or advertiser.

In one embodiment of the invention, corresponding to “active idle” systems, the three-dimensional object 100 is movable and/or manipulable by the user. For example, the user could use a mouse, keyboard, or other input device to rotate the three-dimensional object 100 such that other sides are visible to the user. The user could also use the same input devices to initiate functions or manipulate items appearing on the three-dimensional object 100. For example, the user could use the input devices to press any of the input buttons 160 to start, stop, or alter a media program through the second side 150 of the three-dimensional object 100, or he could reset the clock 130 on the first side 120.

In one embodiment of the present invention, the user is also provided with the ability to modify the three-dimensional object 100. For example, the user can change the shape, color or size of the three-dimensional object 100. In another embodiment, the user can customize the content appearing on the three-dimensional object 100. For example, the user can choose the applications or features that appear on various portions of the three-dimensional object 100, as well as customizing how an application or feature appears to the user. In these instances, the three-dimensional object 100 serves as a true active user interface object for use by the user when the device at issue is in an idle mode. Alternatively, the user can download the three-dimensional object 100 from a remote server, or the three-dimensional object 100 could be provided as part of a service that whose options can be customized by the user.

In addition to the above, various properties of the three-dimensional object 100 can be automatically modified or altered based upon the occurrence of a certain activity. For example, the system of the present invention can include a setting that alters the three-dimensional object 100 at designated time intervals (such as every hour) or alters the position of the three-dimensional object 100. Altering the position of the three-dimensional object 100 can also be associated with individual functions presented on the various sides of the three-dimensional object. As an example, the three-dimensional object 100 can automatically alter its position to a side having a calendar whenever a calendar alert appears, and a change in color or some form of movement on that side is also possible. Similarly, when a user receives a text message, a side of the three-dimensional object 100 having contact information can be moved or altered, and similar actions can be used for a side having a media player when a song is played.

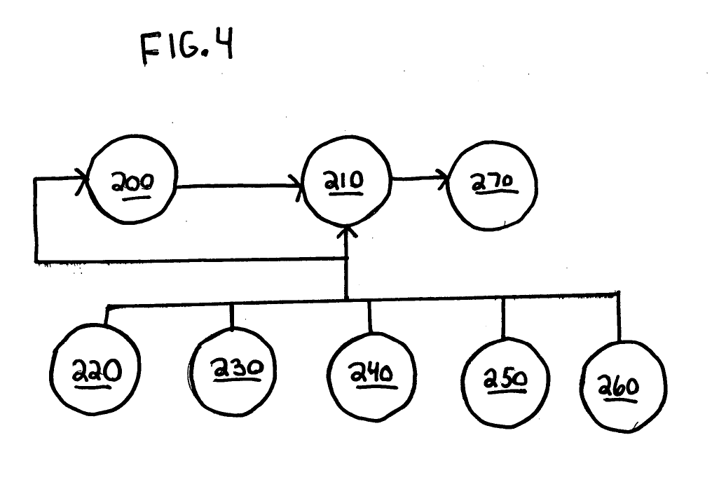

FIG. 4 shows a basic flow chart showing a process for implementing the present invention. At step 200, it is determined or checked whether an electronic device is in an idle mode. It is also possible that she step of determining or checking is skipped so that providing the three-dimensional object 100 on a display is applied without any checking procedures. At step 210, if the electronic device is in an idle mode, the three-dimensional object 100 appears on the display 32. Although steps 200 and 210 are shown sequentially, it is possible for these steps to occur substantially simultaneously. The user is capable of altering the position of the three-dimensional object 100 (at step 220), resizing the three-dimensional object 100 (at step 230), changing the color of the three-dimensional object 100 (at step 240) or reshaping the three-dimensional object 100 (at step 250). The user may also customize the features shown on the three-dimensional object 100 (at step 260) in a variety of manners as discussed above. These actions can occur either when the device is in idle mode or when it is in an active mode depending upon the particular embodiment of the invention. The device, when in idle mode, can also provide an indication to a user of an event or when a change occurs in any of the features that are displayed on the three-dimensional object 100. This is represented at step 270.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of arranging a view on an electronic device, comprising:
presenting a three-dimensional object on a display of the electronic device while the electronic device is in an idle mode, the three-dimensional object including a view being viewable to a user.

2. The method of claim 1, further comprising the step of enabling the user to modify the shape of the three-dimensional object.

3. The method of claim 1, further comprising the step of enabling the user to modify the view appearing on the three-dimensional object.

4. The method of claim 1, further comprising the step of enabling the user to modify the size of the three-dimensional object.

5. The method of claim 1, further comprising the step of providing an indication on the display to the user of an event while the electronic device remains in idle mode.

6. The method of claim 1, wherein content related to the view is selected from the group consisting of text documents, clocks, calendars, spreadsheets, graphic images, video clips, animations, application-in-progress screens for firewall, anti-virus, anti-spy-ware and anti-spam applications, distributed computing project screens, electronic mailboxes, instant message-related screens, weather information, financial information, the user's “to do” list, contact information, service advertisements, product advertisements, sponsor advertisements, user interface components, views and combinations thereof.

7. The method of claim 1, further comprising the step of automatically altering the position of the three-dimensional object in response to an activity.

8. The method of claim 1, further comprising the step of automatically modifying the three-dimensional object in response to an activity.

9. A computer program product for arranging a view on an electronic device, comprising:
computer code for presenting a three-dimensional object on a display of the electronic device while the electronic device is in an idle mode, the three-dimensional object including a view being viewable to a user.

10. The computer program product of claim 9, further comprising computer code for enabling the user to modify the shape of the three-dimensional object.

11. The computer program product of claim 9, further comprising computer code for enabling the user to modify the view appearing on the three-dimensional object.

12. The computer program product of claim 9, further comprising computer code for enabling the user to modify the size of the three-dimensional object.

13. The computer program product of claim 9, further comprising computer code for providing an indication on the display to the user of an event while the electronic device remains in idle mode.

14. The computer program product of claim 9, wherein content related to the view is selected from the group consisting of text documents, clocks, calendars, spreadsheets, graphic images, video clips, animations, application-in-progress screens for firewall, anti-virus, anti-spy-ware and anti-spam applications, distributed computing project screens, electronic mailboxes, instant message-related screens, weather information, financial information, the user's “to do” list, contact information, service advertisements, product advertisements, sponsor advertisements user interface components, views and combinations thereof.

15. The computer program product of claim 9, further comprising computer code for automatically altering the position of the three-dimensional object in response to an activity.

16. The computer program product of claim 9, further comprising computer code for automatically modifying the three-dimensional object in response to an activity.

17. An electronic device, comprising:
a display for exhibiting information;
a processor for processing information to be exhibited by the display; and
a memory unit for storing information to be processed by the processor,
wherein the memory unit includes a computer program product for arranging a view on the display, comprising:
computer code for presenting a three-dimensional object on the display while the electronic device is in an idle mode, the three-dimensional object including the view being viewable to a user.

18. The electronic device of claim 17, wherein the computer program product further comprises computer code for enabling the user to modify the shape of the three-dimensional object.

19. The electronic device of claim 17, wherein the computer program product further comprises computer code for enabling the user to modify the view appearing on the three-dimensional object.

20. The electronic device of claim 17, wherein the computer program product further comprises computer code for enabling the user to modify the size of the three-dimensional object.

21. The electronic device of claim 17, wherein content related to the view is selected from the group consisting of text documents, clocks, calendars, spreadsheets, graphic images, video clips, animations, application-in-progress screens for firewall, anti-virus, anti-spy-ware and anti-spam applications, distributed computing project screens, electronic mailboxes, instant message-related screens, weather information, financial information, the user's “to do” list, contact information, service advertisements, product advertisements, sponsor advertisements, user interface components, views and combinations thereof.

22. The electronic device of claim 17, wherein the computer program product further comprises computer code for automatically altering the position of the three-dimensional object in response to an activity.

23. The electronic device of claim 17, wherein the computer program product further comprises computer code for automatically modifying the three-dimensional object in response to an activity.

24. A user interface for a device for providing information to a user, comprising:
a display for providing information to a user,
wherein the display is adapted for presenting a three-dimensional object on the display while the device is in an idle mode, the three-dimensional object including a view being viewable to the user
